(19) United States
(12) Patent Application Publication
(10) Pub. No.: US 2026/0120935 A1
(43) Pub. Date: Apr. 30, 2026

(54) HEAT GENERATING ELECTRIC COMPONENT TANK

(71) Applicant: Hitachi Energy Ltd, Zürich (CH)

(72) Inventors: Julian Cardona, Holly Springs, NC (US); Remigiusz Lukasz Nowak, Wettingen (SE); Wojciech Koncewicz, Polanczyk (PL); Robert Sekula, Krakow (PL); Boguslaw Samul, Krakow (PL)

(21) Appl. No.: 19/151,310

(22) PCT Filed: Mar. 3, 2023
(86) PCT No.: PCT/EP2023/055505

§ 371 Date: Jul. 26, 2025

Related U.S. Application Data
(60) Provisional application No. 63/445,986, filed on Feb. 15, 2023.

(51) Int. Cl. H01F 27/12; F28F 7/02; H01F 27/08

(52) U.S. Cl. CPC H01F 27/12; F28F 7/02; H01F 27/085

(57) ABSTRACT

A tank for a heat generating electric component including a casing including an interior side, an exterior side, a top portion, a bottom portion, and an intermediate portion between the top portion and the bottom portion; a heat exchanger including a three dimensional lattice cell structure integral with the casing in at least the intermediate portion and extending outwardly from the exterior side, the heat exchanger configured to conduct a dielectric cooling fluid from the casing at the exterior side of the casing for heat exchange with an ambient fluid, and back towards the casing to cool the heat generating electric component.

### CROSS REFERENCE TO RELATED APPLICATIONS

This application is a 35 U.S.C. § 371 national stage application of PCT International Application No. PCT/EP2023/055505 filed on Mar. 3, 2023, which in turn claims domestic priority to U.S. Provisional Ser. No. 63/445,986 , filed on Feb. 15, 2023, the disclosures and content of which are incorporated by reference herein in their entirety.

### TECHNICAL FIELD

The embodiments described herein are generally directed to tanks and heat exchangers for cooling heat generating electric components.

### BACKGROUND

In a typical oil-type distribution transformer, oil inside a transformer tank is cooled by surrounding air through the use of straight cooling fins mounted on tank side walls. To reach a required performance of a transformer, the straight cooling fins need to have a sufficient heat transfer area, which results in a certain footprint of the transformer.

### SUMMARY

Aspects of the disclosure involve a tank for a heat generating electric component comprising a casing including an interior side, an exterior side, a top portion, a bottom portion, and an intermediate portion between the top portion and the bottom portion; a heat exchanger comprising a three dimensional lattice cell structure integral with the casing in at least the intermediate portion and extending outwardly from the exterior side, the heat exchanger configured to conduct a dielectric cooling fluid from the casing at the exterior side of the casing for heat exchange with an ambient fluid, and back towards the casing to cool the heat generating electric component.

One or more implementations of the above aspects comprises one or more of the following: the casing includes a length from the top portion to the bottom portion, and the three dimensional lattice cell structure is integral with the casing along substantially the length of the casing; a fan arrangement arranged to generate a flow of the ambient fluid in the three dimensional lattice cell structure; the casing includes an upper half and a lower half, and the heat exchanger includes one or more fan inlets in the upper half of the casing; the casing includes an upper half and a lower half, and the heat exchanger includes a dielectric cooling fluid inlet in the upper half of the casing and a dielectric cooling fluid outlet in the lower half of the casing; the heat exchanger includes dielectric cooling fluid inlets and dielectric cooling fluid outlets throughout substantially the length of the casing; the three dimensional lattice cell structure includes a closed external side to keep the ambient fluid inside the three dimensional lattice cell structure; the three dimensional lattice cell structure is a triply periodic minimal surface structure; the triply periodic minimal surface structure includes a wall that divides cooling fluid passages therein; the wall that divides cooling fluid passages is configured to conduct the dielectric cooling fluid therethrough, and the cooling fluid passages that the wall divides are ambient fluid cooling fluid passages; and/or the heat exchanger has a surface heat flux greater than 600 W/m² at a flow rate greater than 50 m³/h.

### BRIEF DESCRIPTION OF THE DRAWINGS

The details of the present disclosure, both as to its structure and operation, may be gleaned in part by study of the accompanying drawings, in which like reference numerals refer to like parts, and in which:

FIG. 1 is a simplified schematic of embodiments of a tank for a heat generating electric component;

FIG. 2 is a rear perspective view of an embodiment of tank for a heat generating electric component with a fan arrangement shown;

FIG. 3A is a cross-sectional view of the tank for a heat generating electric component of FIG. 2 and shows a dielectric cooling fluid inlet in an upper half of the tank and a dielectric cooling fluid outlet in a lower half of the tank;

FIG. 3B is a cross-sectional view, similar to FIG. 3A, of another embodiment of a tank for a heat generating electric component and shows dielectric cooling fluid inlets and dielectric cooling fluid outlets throughout substantially the length of the tank;

FIG. 3C is a perspective view of a portion of an embodiment of a three dimensional lattice cell structure of a heat exchanger of the tank, and shows a wall that divides cooling fluid passages therein and conducts dielectric cooling fluid therethrough;

FIG. 4A shows graphs of surface heat flux versus flow rate for an embodiment of a tank for a heat generating electric component and a tank that is cooled by surrounding air through the use of straight cooling fins mounted on tank side walls;

FIG. 4B is a top plan view showing a footprint of the tank that is cooled by surrounding air through the use of straight cooling fins referenced for the graph of FIG. 4A;

FIG. 4C is a top plan view showing a footprint of the embodiment of the tank for a heat generating electric component referenced for the graph of FIG. 4A.

### DETAILED DESCRIPTION

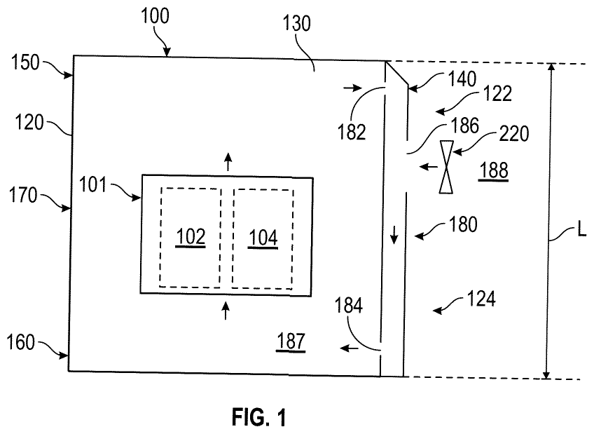

With reference to FIG. 1, an embodiment of a tank 100 for a heat generating electric component 101 such as, but not limited to, a transformer (e.g., oil-type distribution transformer) 102 or a shunt reactor 104 is shown. The tank 100 comprises a casing 120 including an upper half 122, a lower half 124, an interior side 130, and an exterior side 140. The upper half 122 and the lower half 124 are further divided into a top portion 150, a bottom portion 160, and an intermediate portion 170 between the top portion 150 and the bottom portion 160. The casing 120 includes a length L from the top portion 150 to the bottom portion 160. The heat generating electric component 101 is cooled by a heat exchanger 180. The heat exchanger 180 comprises one or more dielectric cooling fluid inlets 182 in the upper half 122 of the casing 120, one or more dielectric cooling fluid outlets 184 in the lower half 124 of the casing 120, and one or more fan inlets 186 in the upper half 122.

The casing 120 and the heat exchanger 180 define a circuit for dielectric cooling fluid (e.g., dielectric oil) 187 comprising the casing 120, the dielectric cooling fluid inlet 182, the heat exchanger 180, and the dielectric cooling fluid outlet 184. The dielectric cooling fluid 187 flows in this circuit in a clockwise direction during operation of the heat generating electric component 101. As shown by the arrows, the dielectric cooling fluid 187 that the heat generating electric component 101 is submerged in is heated by the heat generating electric component 101. The hot dielectric cooling fluid 187 then enters the heat exchanger 180 through the dielectric cooling fluid inlet 182. The hot dielectric cooling fluid 187 is then cooled by heat exchange with ambient fluid (e.g., air) 188 as the hot dielectric cooling fluid 187 travels through the heat exchanger 180 at the exterior side 140 of the casing 120. Cold dielectric cooling fluid 187 then exits the heat exchanger 180 through the dielectric cooling fluid outlet 184. The heat generating electric component 101 is then cooled by the dielectric cooling fluid 187.

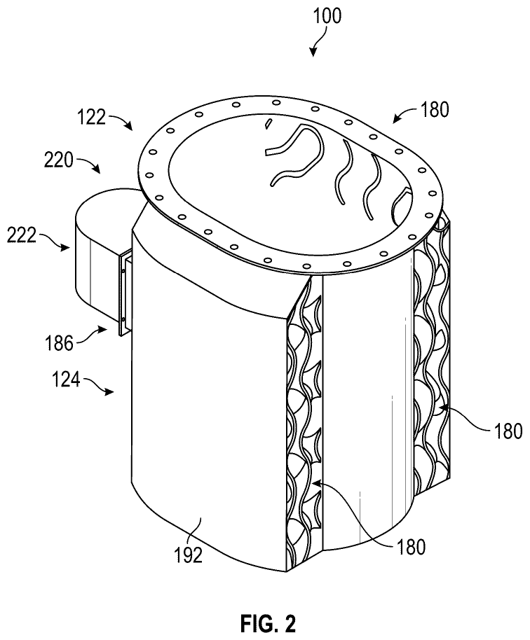

With reference to FIG. 2, the heat exchanger 180 comprises a three dimensional lattice cell structure 190 that is integral with the casing 120 along substantially (i.e., greater than 50%) the length L of the casing 120, in at least the intermediate portion 170, and extending outwardly from the exterior side 140. The three dimensional lattice cell structure 190 includes a closed external side 192 that keeps the ambient fluid 188 inside the three dimensional lattice cell structure 190. The closed external side 192 provides the technical advantage(s) of preventing forced air from escaping and forcing the air to flow to the end of the structure, improving thermal efficiency. The integrated heat exchanger 180 and casing 120 is additively manufactured (e.g., 3D printed). Consequently, the heat exchanger 180 does not have to be later attached to the tank 100 as the heat exchanger 180 is embedded in the tank 100 from the beginning. A technical advantage of this integrated solution is that it provides an opportunity to manufacture the tank and the heat exchanger without welding, minimizing risk of oil leakages.

A fan arrangement 220 including one or more fans 222 at the respective one or more fan inlets 186 in the upper half 122, where hot dielectric cooling fluid 187 enters the heat exchanger 180, provide forced air cooling by generating a flow of the ambient fluid 188 in the three dimensional lattice cell structure 190. A technical advantage of the fan(s) 222/fan inlets 186 in the upper half 122 is the cooler air with higher velocity cools the hotter cooling dielectric fluid 187, improving the chimney effect in the tank 100. Further, by locating the fans on the same side of the tank 100, the footprint of the tank 100 is reduced. In alternative embodiments, the one or more fans 222 may be disposed at one or more locations on the heat exchanger 180 other than those shown.

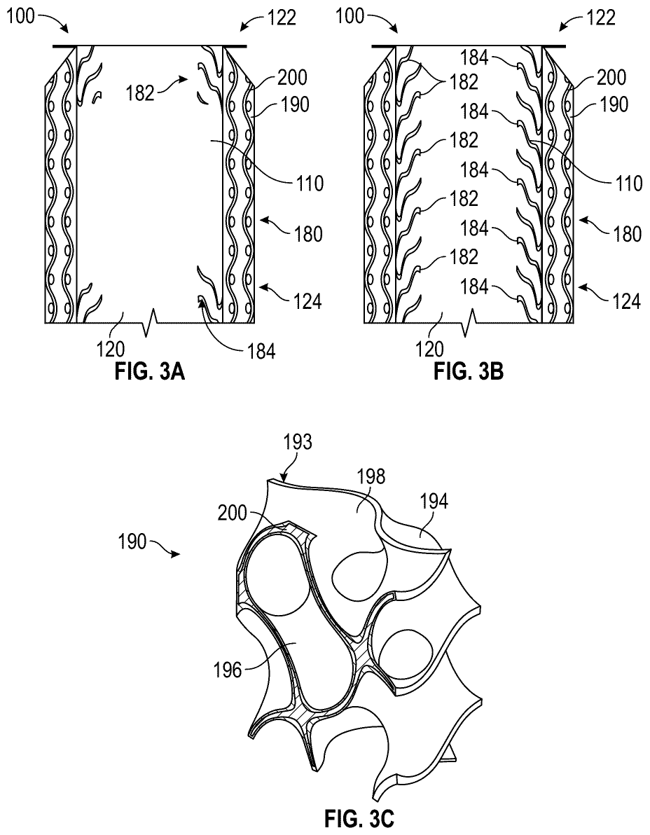

With reference to FIG. 3A, the one or more dielectric cooling fluid inlets 182 in the upper half 122 of the casing 120, and the one or more dielectric cooling fluid outlets 184 in the lower half 124 of the casing 120 are shown. A technical advantage of cooling fluid inlets/outlets 182, 184 in the lower/upper half 124, 122 is enhancement of the chimney effect in the tank 100 by causing the hotter dielectric cooling fluid 187 to enter from the top and run the full length of the heat exchanger 180.

With reference to FIG. 3B, in an alternative embodiment, the heat exchanger 180 includes dielectric cooling fluid inlets 182 and dielectric cooling fluid outlets 184 throughout substantially the full length L of the casing 120.

With reference to FIG. 3C, the three dimensional lattice cell structure 190 is a hybrid triply periodic minimal surface (“TPMS”) structure 193 including a hollow wall 194 that divides cooling fluid passages 196, 198 therein. The dielectric cooling fluid 187 travels within the hollow wall 194 and the ambient fluid 188 travels within the cooling fluid passages 196, 198 along the hollow wall 194, cooling the dielectric cooling fluid 187 in the hollow wall 194. This hybrid structure 193, compared to a TPMS structure where the wall 194 is solid, cools down the dielectric cooling fluid 187 on ambient-fluid side more efficiently and reduces the amount of dielectric cooling fluid 187 required. Further, the ambient fluid pressure drop across the heat exchanger 180 is much less compared to the TPMS structure where the wall 194 is solid because the hybrid TPMS structure 193 has double the channel volume for ambient fluid 188. Thus, the hybrid TPMS structure 193 is a more efficient system than the TPMS structure where the wall 194 is solid, which requires more volume to reach the same amount of heat extraction at given flow rate and cold fluid to be passed by half the volume, increasing pressure losses.

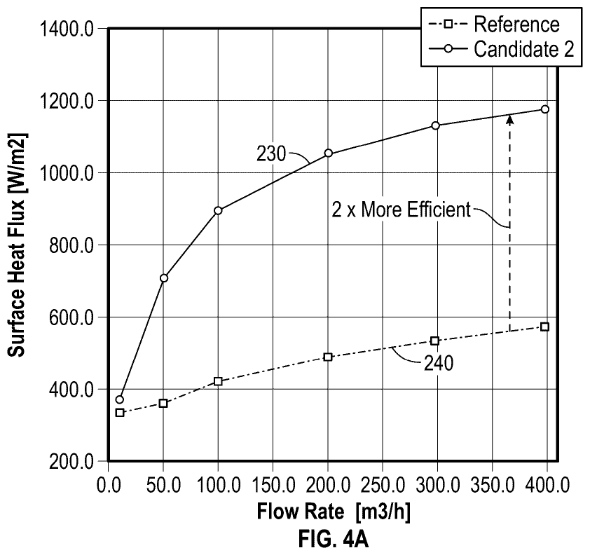

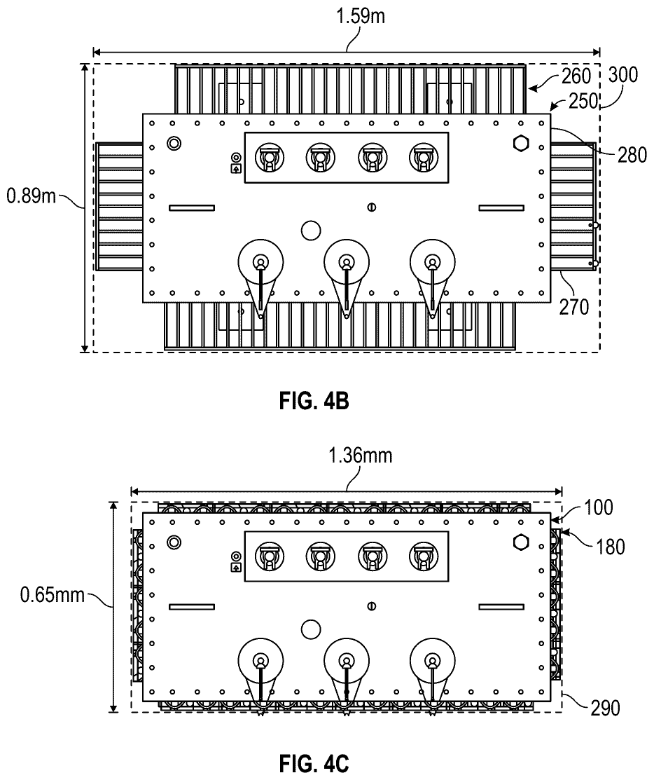

FIG. 4A illustrates a graph 230 of surface heat flux (W/m², heat transfer rate normalized by TPMS surface area) versus flow rate (m³/h) for the tank 100 and a graph 240 of surface heat flux versus flow rate for a reference tank 250 (FIG. 4B), which includes heat exchanger 260 that is cooled by surrounding air through the use of straight cooling fins 270 mounted on tank side walls 280. Not only is a footprint 290 (FIG. 4C) of the tank 100 significantly smaller (e.g., 37% less area) than a footprint 300 of the tank 250, but the surface heat flux at a given flow rate is significantly higher for the tank 100 compared to the tank 250. The tank 100 has a surface heat flux greater than 600 W/m² at a flow rate greater than 50 m³/h. Thus, the integrated heat exchanger 180 and casing 120 and hybrid TPMS structure 193 of the tank 100 significantly increase electric component heat flux, allowing the footprint 290 of the tank 100 to be significantly smaller.

The above description of the disclosed embodiments is provided to enable a person skilled in the art to make or use the disclosure. Various modifications to these embodiments will be readily apparent to those skilled in the art, and the general principles described herein can be applied to other embodiments without departing from the spirit or scope of the disclosure. Thus, it is to be understood that the description and drawings presented herein represent an embodiment of the disclosure and are therefore representative of the subject matter which is broadly contemplated by the present disclosure. It is further understood that the scope of the present disclosure fully encompasses other embodiments that may become obvious to those skilled in the art and that the scope of the present disclosure is accordingly not limited.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

1-9. (canceled)

10. A tank for a heat generating electric component, comprising:
a casing including an interior side, an exterior side, a top portion, a bottom portion, and an intermediate portion between the top portion and the bottom portion;
a heat exchanger comprising a three dimensional lattice cell structure integral with the casing in at least the intermediate portion and extending outwardly from the exterior side, the heat exchanger configured to conduct a dielectric cooling fluid from the casing at the exterior side of the casing for heat exchange with an ambient fluid, and back towards the casing to cool the heat generating electric component;
wherein the casing includes an upper half and a lower half, and the heat exchanger includes one or more fan inlets in the upper half of the casing, the one or more fan inlets being configured to receive a flow of the ambient fluid generated by one or more fans;
wherein the three dimensional lattice cell structure includes a closed external side to keep the ambient fluid inside the three dimensional lattice cell structure.

11. The tank of claim 10, wherein the casing includes a length from the top portion to the bottom portion, and the three dimensional lattice cell structure is integral with the casing along substantially the length of the casing.

12. The tank according to claim 10, further comprising a fan arrangement comprising the one or more fans arranged to generate the flow of the ambient fluid.

13. The tank according to claim 10, wherein the heat exchanger includes a dielectric cooling fluid inlet in the upper half of the casing and a dielectric cooling fluid outlet in the lower half of the casing.

14. The tank according to claim 10, wherein the heat exchanger includes dielectric cooling fluid inlets and dielectric cooling fluid outlets throughout substantially the length of the casing.

15. The tank according to claim 10, wherein the three dimensional lattice cell structure is a triply periodic minimal surface structure.

16. The tank of claim 15, wherein the triply periodic minimal surface structure includes a wall that divides cooling fluid passages therein.

17. The tank of claim 16, wherein the wall that divides cooling fluid passages is configured to conduct the dielectric cooling fluid therethrough, and the cooling fluid passages that the wall divides are ambient fluid cooling fluid passages.

18. The tank according to claim 10, wherein the heat exchanger has a surface heat flux greater than 600 W/m² at a flow rate of the flow of the ambient fluid greater than 50 m³/h.
